(19) United States
(12) Patent Application Publication
(10) Pub. No.: US 2026/0124988 A1
(43) Pub. Date: May 7, 2026

(54) VEHICLE CABIN INTERIOR ENVIRONMENTAL CONTROL DEVICE

(71) Applicant: TOYOTA JIDOSHA KABUSHIKI KAISHA, Toyota-shi (JP)

(72) Inventors: Yuto KOROGI, Nagakute-shi (JP); Hiromichi YAMABE, Aichi-gun (JP); Chie FUKUHARA, Toyota-shi (JP); Nobuyuki IWASAKI, Okazaki-shi (JP); Mihoko FUJIHARA, Anjo-shi (JP); Hiroyuki SATAKE, Toyota-shi (JP); Kohei MINAMI, Toyota-shi (JP)

(21) Appl. No.: 19/347,721

(22) Filed: Oct. 2, 2025

(30) Foreign Application Priority Data
Nov. 5, 2024 (JP) 2024-193976

(51) Int. Cl. B60Q 3/20; B60H 1/00; B60Q 9/00

(52) U.S. Cl. CPC B60Q 3/20; B60H 1/0073; B60Q 9/00

(57) ABSTRACT

A vehicle cabin interior environmental control device includes a processor and a memory coupled to the processor. The processor is configured to receive switching of a vehicle cabin interior environment, and to change the vehicle cabin interior environment by controlling at least a lighting device and an acoustic device. The processor carries out a predetermined start notification by controlling the lighting device and the acoustic device at a time of a start of changing of the vehicle cabin interior environment, and carries out a predetermined end notification by controlling the lighting device and the acoustic device at a time of an end of the changing of the vehicle cabin interior environment.

### CROSS-REFERENCE TO RELATED APPLICATION

This application is based on and claims priority under 35 USC 119 from Japanese Patent Application No. 2024-193976, filed on Nov. 5, 2024, the disclosure of which is incorporated by reference herein.

### BACKGROUND

### Technical Field

The present disclosure relates to a vehicle cabin interior environmental control device.

### Related Art

Japanese Patent Application Laid-Open (JP-A) No. 2022-041858 discloses technology for appropriately adjusting an environment of a vehicle cabin interior according to an atmosphere produced by plural occupants. JP-A No. 2022-041858 discloses a vehicle interior system that estimates an atmosphere of a vehicle cabin interior produced by plural occupants from sound detected by a sound detection section, and adjusts the environment of the vehicle cabin interior according to the estimated atmosphere.

In the prior art, since rendering of an environmental change is executed without prior notice, there is a problem in that an occupant cannot easily grasp that the vehicle cabin interior environment has been switched and that the rendering of an environmental change is being executed. Similarly, there is a problem in that it is also difficult to grasp a switch to another environmental change or an end thereof.

### SUMMARY

The present disclosure provides a vehicle cabin interior environmental control device that enables an occupant to easily grasp switching of a vehicle cabin interior environment.

A vehicle cabin interior environmental control device according to a first aspect includes a processor and a memory coupled to the processor, the processor being configured to receive switching of a vehicle cabin interior environment, and to change the vehicle cabin interior environment by controlling at least a lighting device and an acoustic device, wherein the processor carries out a predetermined start notification by controlling the lighting device and the acoustic device at a time of a start of changing of the vehicle cabin interior environment, and carries out a predetermined end notification by controlling the lighting device and the acoustic device at a time of an end of the changing of the vehicle cabin interior environment. Due to notification of the start and the end in this manner, an occupant is made to easily grasp switching of the vehicle cabin interior environment.

A vehicle cabin interior environmental control device according to a second aspect is the vehicle cabin interior environmental control device according to the first aspect, wherein: the vehicle cabin interior environment may be changed to correspond to one of plural modes; and in a case in which the processor receives, during execution of environmental change of a mode, switching of the mode of the vehicle cabin interior environment, the processor carries out the start notification, without carrying out the end notification. According to the vehicle cabin interior environmental control device according to the second aspect, switching of the environment can be smoothly carried out, and notification can be provided to the occupant.

A vehicle cabin interior environmental control device according to a third aspect is the vehicle cabin interior environmental control device according to the first aspect, wherein the vehicle cabin interior environment may be changed to correspond to one of plural modes, only one type of the start notification is set, and only one type of the end notification is set. According to the vehicle cabin interior environmental control device according to the third aspect, by carrying out uniform types of the start notification and the end notification, the occupant can be made to easily recognize the start and the end of the environmental change.

A vehicle cabin interior environmental control device according to a fourth aspect is the vehicle cabin interior environmental control device according to the first aspect, wherein: the vehicle cabin interior environment may be changed correspond to one of plural modes, and a type of the start notification and a type of the end notification are set for each of the plural modes; the processor carries out the start notification of a type corresponding to a mode for which switching has been received; and the processor carries out the end notification of a type corresponding to the mode for which switching has been received. According to the vehicle cabin interior environmental control device according to the fourth aspect, by carrying out types of the start notification and the end notification that have been set for each mode, the occupant can be made to easily distinguish what environmental change is being executed.

A vehicle cabin interior environmental control device according to a fifth aspect is the vehicle cabin interior environmental control device according to the first aspect, wherein: in a case in which the processor changes the vehicle cabin interior environment by further controlling a seat device, the processor carries out control of a preliminary operation at the time of the start; and the processor provides notification, in the start notification, that control of a seat will start, in conjunction with control of the preliminary operation of the seat device. According to the vehicle cabin interior environmental control device according to the fifth aspect, by inserting a notification at a time of the preliminary operation, the occupant can be provided with a sense of security.

The technology of the present disclosure enables an occupant to easily grasp switching of a vehicle cabin interior environment.

### BRIEF DESCRIPTION OF THE DRAWINGS

An exemplary embodiment of the present disclosure will be described in detail based on the following figures, wherein:

FIG. 1 is a block diagram illustrating a hardware configuration of a vehicle;

FIG. 2 is a diagram illustrating time periods of operational content of a mode for changing a vehicle cabin interior environment; and

FIG. 3 is a flowchart illustrating a flow of specific processing that is executed by an environmental control ECU.

### DETAILED DESCRIPTION

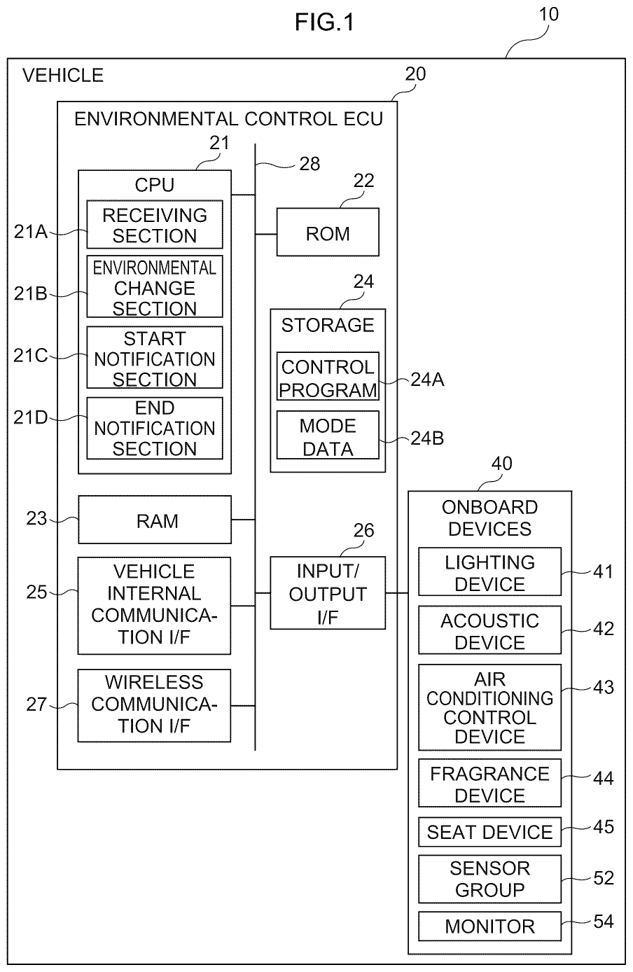

FIG. 1 is a block diagram illustrating a hardware configuration of a vehicle 10. As illustrated in FIG. 1, the vehicle 10 includes an environmental control electronic control unit (ECU) 20. The vehicle 10 is an example of the “vehicle” of the present disclosure, and the environmental control ECU 20 is an example of the “vehicle cabin interior environmental control device” of the present disclosure.

The environmental control ECU 20 is configured to include a central processing unit (CPU) 21, a read only memory (ROM) 22, a random access memory (RAM) 23, a storage 24, a vehicle internal communication interface (I/F) 25, an input/output I/F 26, and a wireless communication I/F 27. The CPU 21, the ROM 22, the RAM 23, the storage 24, the vehicle internal communication I/F 25, the input/output I/F 26, and the wireless communication I/F 27 are connected so as to be capable of communicating with each other via an internal bus 28.

The CPU 21 is a central arithmetic processing unit that executes various kinds of programs and controls various sections. That is to say, the CPU 21 reads out programs from the ROM 22 or the storage 24, and executes the programs using the RAM 23 as a workspace. The CPU 21 controls the aforementioned respective configurations and performs various kinds of arithmetic processing according to the programs recorded in the ROM 22 or the storage 24.

The ROM 22 stores various kinds of programs and various kinds of data. The RAM 23 serves as a workspace to temporarily store programs and data.

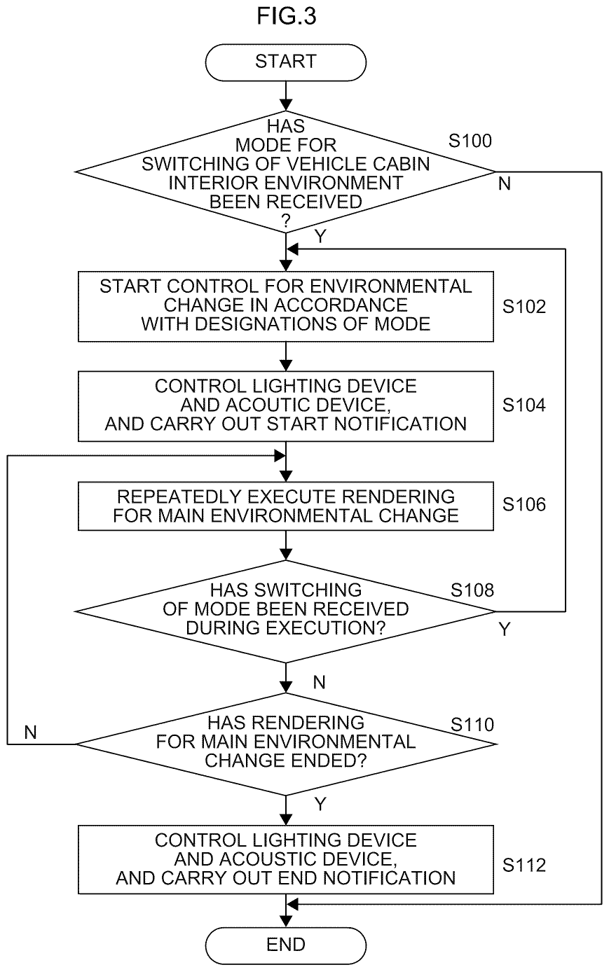

The storage 24 is configured by a storage device such as an embedded multimedia card (eMMC), a universal flash storage (UFS) or the like, and stores various kinds of programs and various kinds of data. The storage 24 stores a control program 24A and mode data 24B. The control program 24A is a program for causing the CPU 21 to execute specific processing (refer to FIG. 3), which will be described below. The mode data 24B is setting data in which patterns of plural modes for changing a vehicle cabin interior environment are stored. The plural modes will be described later.

The vehicle internal communication I/F 25 is an interface for connecting to other ECUs. A communication standard according to the CAN protocol is used for this interface. The vehicle internal communication I/F 25 is connected to an external bus 29. It should be noted that, although not illustrated in the drawings, plural ECUs are provided for each function of the vehicle 10.

The input/output I/F 26 is an interface for communicating with onboard devices 40 that are installed at the vehicle 10.

The wireless communication I/F 27 is a wireless communication module for communicating with external devices. For example, a communication standard such as 5G, LTE, Wi-Fi (registered trademark), Bluetooth (registered trademark) or the like is used for the wireless communication module.

The onboard devices 40 are various kinds of devices that are installed at the vehicle 10. The vehicle 10 includes, as an example of the onboard devices 40, a lighting device 41, an acoustic device 42, an air conditioning control device 43, a fragrance device 44, and a seat device 45. It should be noted that the respective devices of the onboard devices 40 are appropriately installed at a periphery of a seat, at a roof, or the like, of the vehicle cabin interior, as plural devices required for environmental change.

The lighting device 41 is a device that controls turning on and turning off of lighting at the vehicle cabin interior. Moreover, the lighting device 41 is capable of rendering illumination or the like by controlling turning on of the lighting in a specific pattern, and for example, is capable of rendering in which patterns of a warm color system and a cold color system are switched. The acoustic device 42 is a device that causes music and navigation sounds to play within the vehicle cabin. The air conditioning control device 43 is a device that adjusts a temperature within the vehicle cabin. The fragrance device 44 is a device that disperses fragrance within the vehicle cabin, and disperses a specific fragrance specified in a mode to a periphery of the seat to thereby promote a relaxation effect for an occupant. The seat device 45 is a device that controls behavior of a seat within the vehicle cabin. The seat device 45 controls preliminary operation at a time of a start (A1) of a mode and main operation during execution (A2) thereof. For example, in a case in which control to tilt the seat is carried out in the main operation, the preliminary operation carries out behavior to tilt the seat about several percent in a direction in which the seat is to be tilted, and carries out behavior to cause an occupant to recognize that the seat will now be tilted. Further, the seat device 45 may control the behavior of the seat so as to be tilted in a manner that matches with a melody of music or the dispersing of a fragrance. Alternatively, the behavior of the seat may be controlled so as to tilt at a constant speed, which is optimized in the mode, regardless of a physical build of the occupant. By controlling the tilting of the seat in this manner, tension relief and relaxation of the occupant is induced.

A sensor group 52 includes, for example, sensors for detecting states of the vehicle 10 and circumstances at a periphery of the vehicle 10, such as a 3D-LiDAR, a millimeter-wave sensor, an infrared sensor, a turn signal sensor, an accelerator position sensor, a vehicle speed sensor, a steering angle sensor, an angular velocity sensor, a global positioning system (GPS) sensor, an illuminance sensor, a gyro sensor, an acceleration sensor, and the like, as well as plural cameras that image the periphery of the vehicle 10. The sensor group 52 outputs detection results from the respective sensors and captured images from the respective cameras to the environmental control ECU 20, other ECUs, and the like.

A monitor 54 is a display that is provided at a meter panel arranged in front of a driver's seat of the vehicle 10, and that is for displaying images, video, and the like in accordance with switching of the vehicle cabin interior environment. The monitor 54 is an example of the “display section” of the present disclosure. It should be noted that the monitor 54 is not limited to being provided at a meter panel in front of the driver's seat, and may be provided at a periphery of the driver's seat or at a periphery of another seat.

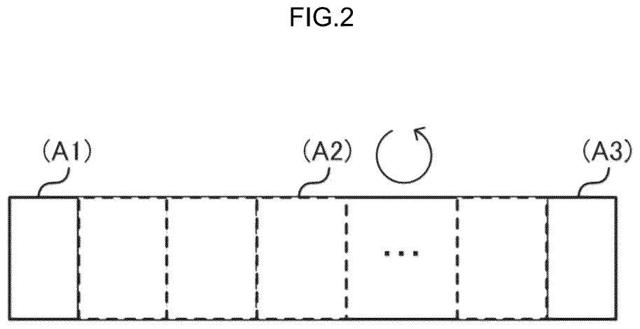

The mode data 24B includes settings for changing of the vehicle cabin interior environment corresponding to plural modes. An example of the plural modes in the mode data 24B will be explained. FIG. 2 is a diagram illustrating time periods of operational content of a mode for changing the vehicle cabin interior environment. As illustrated in FIG. 2, in chronological order, the operational content starts from operation of a start (A1) at an opening, operation during execution (A2) at a main portion is performed, and operation of the series of modes is completed with operation of an end (A3) at an ending. Operation time periods of the start (A1) and the end (A3) are set to from 5 to 10 seconds. An operation time period during execution (A2) is appropriately set to a time period corresponding to the settings of the mode, such as, for example, from 1 minute to 3 hours and 59 minutes.

In the operation of the start (A1) and the end (A3), rendering due to light of lighting by the lighting device 41, music from the acoustic device 42, and preliminary operation of the seat device 45 are operated in conjunction with each other to thereby carry out rendering at the time of introduction, switching or ending of an environmental change. Alternatively, opening and ending video may be played at the monitor 54. Due to such rendering, a “sense of immersion” or a “sense of ceremony” is rendered in a multi-sensory manner. Operation accompanying such an opening rendering is an example of a start notification of the present disclosure. Further, operation accompanying such an ending rendering is an example of an end notification of the present disclosure.

In the operation during execution (A2), the rendering by the respective devices of the onboard devices 40 is repeated plural times. By carrying out the rendering according to a cycle of the rendering due to light of the lighting by the lighting device 41, music from the acoustic device 42, and fluctuation in an air conditioning temperature of the air conditioning control device 43, environmental changes for inducing states such as “falling sleep”, “relaxation maintenance”, “uplift” and the like of an occupant are rendered in a multi-sensory manner. Furthermore, according to a color and brightness of lighting by the lighting device 41, the air conditioning temperature of the air conditioning control device 43, and the dispersing of fragrance by the fragrance device 44, environmental changes for inducing an “alertness level” of the occupant are rendered in a multi-sensory manner.

As described above, rendering by music, video, lighting and the like are divided into opening, main, and ending portions, and an overall length can be adjusted according to a number of repetitions of the main portion. Furthermore, by separately providing the opening portion and the ending portion from each other, the start and the end can be predicted.

Examples of types of modes include, for example, a Lucidity mode, a Revitalization mode, an Inspiration mode, and an Arrange Tune mode, which is customized by an occupant, in addition to a normal mode. Examples of a context in which the Lucidity mode is selected include a case in which one's focus has been reduced due to monotonous driving or a case in which one wishes to immediately switch their state of mind. As biological influences of the Lucidity mode, the vehicle cabin interior environment is adjusted so as to carry out an operation in which a cool breeze and a fragrance having a cooling effect are applied to a face. The Lucidity mode is executed due to control of the lighting device 41, the acoustic device 42, the air conditioning control device 43, and the fragrance device 44. Examples of a context in which the Revitalization mode is selected include a case in which one is under stress due to traffic congestion, and a case in which one wishes to immediately switch their state of mind and establish a relaxed environment. As biological influences of the Revitalization mode, adjustment is made to a temperature environment with reduced sympathetic nervous activity, sound and light that are matched with breathing, and stimulation of a back by tilting the seat. The Revitalization mode is executed due to control of all devices of the onboard devices 40. Examples of a context in which the Inspiration mode is selected include a case in which one wishes to raise their spirits before arrival. It should be noted that these types of modes are merely an example, and it goes without saying that types of modes that envision various contexts, and manners of control of the onboard devices 40 in consideration of biological influences according to the types, can be established.

The CPU 21 of the environmental control ECU 20 includes, as functional configurations, a receiving section 21A, an environmental change section 21B, a start notification section 21C, and an end notification section 21D. The respective functional configurations are realized by the CPU 21 reading out and executing the control program 24A that is stored in the storage 24.

In a case in which a mode designating switching of the vehicle cabin interior environment has been received, the environment change section 21B changes the vehicle cabin interior environment by controlling the respective devices of the onboard devices 40 in accordance with the mode for which switching has been received.

The start notification section 21C carries out the start notification described above by controlling the lighting device 41 and the acoustic device 42 at the time of the start of the environment change by the environmental change section.

Further, in a case in which control of the air conditioning control device 43 is performed, the start notification section 21C may provide notification that adjustment of the air conditioning is to be started, in the start notification, before starting the control in conjunction with the start of the control of the air conditioning. For example, notification relating to the control of the air conditioning is performed by a sound, such as a sound stating “The temperature within the cabin will rise.” or the like, as a navigation sound via the acoustic device 42. Furthermore, in a case in which control of the fragrance device 44 is performed, the start notification section 21C may provide notification that dispersing of fragrance is to be started, in the start notification, before starting the control in conjunction with the start of control for dispersing of the fragrance. For example, the notification relating to the control of the fragrance is performed by a sound, such as a sound stating “The scent within the cabin will change.” or the like, as a navigation sound via the acoustic device 42.

Furthermore, in a case in which control of the seat device 45 is performed, the start notification section 21C may provide notification that control of the seat is to be started, in the start notification, at the time of the start of the control in conjunction with a preliminary operation for the start of the control of the seat. For example, the notification relating to the control of the seat is performed by a sound, such as a sound stating “The seat will be slowly moved. Please be careful.” or the like, as a navigation sound via the acoustic device 42.

The end notification section 21D performs end notification by controlling the lighting device 41 and the acoustic device 42 at the time of the end of the environmental change.

### Flow of Control

FIG. 3 is a flowchart illustrating a flow of specific processing executed by the environmental control ECU 20. The specific processing is carried out by the CPU 21 reading out the control program 24A from the storage 24, and expanding and executing the control program 24A in the RAM 23. As an example, the specific processing is repeatedly and automatically carried out each time a certain period of time elapses.

At step S100, the receiving section 21A determines whether or not a mode for switching of the vehicle cabin interior environment has been received. In a case in which switching has been received, the processing transitions to step S102, and in a case in which switching has not been received, the processing is ended.

At step S102, the environmental change section 21B controls the onboard devices 40 in accordance with the designations of the received mode, to thereby start control for environmental change with respect to the vehicle cabin interior environment.

At step S104, at the time of the start of the environmental change by the environmental change section, the start notification section 21C controls the lighting device 41 and the acoustic device 42 and carries out start notification.

At step S106, the environmental change section 21B controls the respective devices of the onboard devices 40 so as to repeatedly execute the rendering for the main environmental change that is set in the mode.

At step S108, the environmental change section 21B determines whether or not switching of the mode has been received during execution of the rendering for the main environmental change. In a case in which switching of the mode has been received during execution, the processing transitions to step S102, and in a case in which it has not been received, the processing transitions to step S110. In this manner, in a case in which switching of the mode has been received during execution of the rendering for the environmental change of the mode, rendering for the environmental change of the switched mode is started, and the start notification is carried out, without carrying out the end notification. Consequently, switching of the environment can be smoothly carried out, and the occupant can be notified thereof.

At step S110, it is determined whether or not the rendering for the main environmental change has ended. In a case in which it has ended, the processing transitions to step S112, and in a case in which it has not ended, the processing returns to step S106 to repeat the rendering for the main environmental change.

At step S112, at the time of the end of the environmental change, the end notification section 21D controls the lighting device 41 and the acoustic device 42 and carries out end notification.

As described above, according to the vehicle cabin interior environmental control device of the present exemplary embodiment, an occupant can be made to easily grasp switching of the vehicle cabin interior environment.

Further, there is no limitation to the exemplary embodiment that has been described above, and various modifications are possible. For example, control may be performed such that the setting of modes is linked with a terminal of a passenger, and the mode at a time of boarding is switched automatically. Further, a configuration may be provided in which a video representing the rendering, such as the lighting, the sound, or the seat movement when the mode has been switched, can be viewed on the passenger's terminal in advance. Consequently, the rendering for the environmental changes according to the modes can be grasped in advance, and this can lead to elimination of psychological barriers to implementing the environmental changes and to stress reduction.

Further, a configuration may be provided in which the environmental change section sets only one type of the start notification of the start notification section 21C and only one type of the end notification of the end notification section 21D, and the types are uniform for each mode, without providing different notifications for each mode. Consequently, the start and the end of the environmental changes can be easily recognized by the occupant. Alternatively, the type of notification may be set for each mode. In that case, the start notification section 21C performs the type of start notification corresponding to the mode for which switching has been received at the environmental change section 21B. The end notification section 21D performs the type of end notification corresponding to the mode for which switching has been received at the environmental change section 21B. Consequently, the occupant can easily distinguish what environmental change is being executed.

It should be noted that the various processing that is executed due to the CPU 11 reading and executing software (programs) in the above-described exemplary embodiment may be executed by various types of processors other than a CPU. Examples of the processor in such a case include programmable logic devices (PLDs) whose circuit configurations can be changed after production, such as field-programmable gate arrays (FPGAs) or the like, and dedicated electrical circuits, which are processors having circuit configurations designed exclusively for performing specific processing, such as graphics processing units (GPUs), application specific integrated circuits (ASICs) or the like.

Further, the respective processing described above may be executed by any one of these various types of processors, or may be executed by a combination of two or more processors of the same type or different types (for example, plural FPGAs, a combination of a CPU and an FPGA, or the like). Furthermore, the hardware structure of these various types of processors is, more specifically, an electrical circuit in which circuit elements such as semiconductor elements or the like are combined.

Further, in the above-described exemplary embodiment, an aspect has been explained in which the information processing programs are stored (installed) in advance in a non-transitory, computer-readable recording medium. For example, the information processing programs are stored in advance in the ROM 12 or the storage 14. However, there is no limitation thereto, and the respective programs may be provided in a format recorded on a non-transitory recording medium such as a compact disc read only memory (CD-ROM), a digital versatile disc read only memory (DVD-ROM), a universal serial bus (USB) memory or the like. Alternatively, the information processing programs may be provided in a format that is downloaded from an external device via a network.

The flow of processing that has been explained in the above-described exemplary embodiment is one example, and unnecessary steps may be eliminated, new steps may be added, and the processing order may be rearranged, within a range that does not depart from the gist of the present disclosure.

What is claimed is:

1. A vehicle cabin interior environmental control device comprising:
a processor; and
a memory coupled to the processor,
the processor being configured to receive switching of a vehicle cabin interior environment, and to change the vehicle cabin interior environment by controlling at least a lighting device and an acoustic device,
wherein the processor:
carries out a predetermined start notification by controlling the lighting device and the acoustic device at a time of a start of changing of the vehicle cabin interior environment, and
carries out a predetermined end notification by controlling the lighting device and the acoustic device at a time of an end of the changing of the vehicle cabin interior environment.

2. The vehicle cabin interior environmental control device according to claim 1, wherein:
the vehicle cabin interior environment may be changed to correspond to one of a plurality of modes ; and
in a case in which the processor receives, during execution of environmental change of a mode, switching of the mode of the vehicle cabin interior environment, the processor carries out the start notification, without carrying out the end notification.

3. The vehicle cabin interior environmental control device according to claim 1, wherein the vehicle cabin interior environment may be changed to correspond to one of a plurality of modes, only one type of the start notification is set, and only one type of the end notification is set.

4. The vehicle cabin interior environmental control device according to claim 1, wherein:
the vehicle cabin interior environment may be changed to correspond to one of a plurality of modes, and a type of the start notification and a type of the end notification are set for each of the plurality of modes;
the processor carries out the start notification of a type corresponding to a mode for which switching has been received; and
the processor carries out the end notification of a type corresponding to the mode for which switching has been received.

5. The vehicle cabin interior environmental control device according to claim 1, wherein:
in a case in which the processor changes the vehicle cabin interior environment by further controlling a seat device, the processor carries out control of a preliminary operation at the time of the start; and
the processor provides notification, in the start notification, that control of a seat will start, in conjunction with control of the preliminary operation of the seat device.
